(19) United States
(12) Patent Application Publication
(10) Pub. No.: US 2026/0030504 A1
(43) Pub. Date: Jan. 29, 2026

(54) PRESCRIPTION MODELS THROUGH HUMAN-LIKE EXPLANATIONS USING CONTEXT PROMPT DESIGN

(71) Applicant: Dell Products L.P., Round Rock, TX (US)

(72) Inventors: Eduarda Tatiane Caetano Chagas, Maceió (BR); Leandro Takeshi Hattori, Campo Grande (BR); Maira Beatriz Hernandez Moran, Rio de Janeiro (BR); Yanexis Pupo Toledo, Niterói (BR)

(21) Appl. No.: 18/785,440

(22) Filed: Jul. 26, 2024

(51) Int. Cl. G06N 3/0895

(52) U.S. Cl. CPC G06N 3/0895

(57) ABSTRACT

A system for prescription models with human like explanations are provided using context prompt design. Inference data associated with execution of a trained model is generated and context information is extracted from the inference data to build a prompt or prescription. The prescription is input to a large language model and an output of the large language model is a user-friendly or human like explanation of the model and/or the model's operation. Aspects of the prescription are validated and used to generate a validation database that can be used to improve the prescription and/or fine-tune the large language model.

### TECHNOLOGICAL FIELD OF THE DISCLOSURE

Embodiments disclosed herein generally relate to prescriptive prompts and machine learning models and/or artificial intelligence. More particularly, at least some embodiments relate to systems, hardware, software, computer-readable media, and methods for explainability in prescriptive solutions to predictive machine learning.

### BACKGROUND

Machine learning models are often configured to make predictions or inferences. A prescriptive approach takes an additional step of identifying or providing recommendations to improve the predictions or to achieve specific outcomes. For example, a predictive approach may generate a prediction about when a problem will occur while a prescriptive approach not only predicts when the problem will occur but also provides recommendations on how to address or resolve the problem.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of prescriptive systems and methods in machine learning and artificial intelligence;

FIG. 2 discloses aspects of obtaining data related to the operation of a machine learning model;

FIG. 3 discloses aspects of extracting context data from data associated with the operation of a machine learning model;

FIG. 4 discloses aspects of performing prescription analysis using prompt design with the extracted context data;

FIG. 5 discloses aspects of performance analysis; and

FIG. 6 discloses aspects of a computing device, system, or entity.

### DETAILED DESCRIPTION OF SOME EXAMPLE EMBODIMENTS

Embodiments disclosed herein generally relate to prescriptive approaches in machine learning. More particularly, at least some embodiments relate to systems, hardware, software, computer-readable media, and methods for end-to-end explainability with user-friendly explanations (e.g., in natural language).

Explainable artificial intelligence (XAI) is an attempt to explain, by way of example, the output and function of a machine learning model. Examples of XAI include, but are not limited to, interpretable models, feature importance, and example-based XAI. Embodiments of the invention relate to using XAI to prompt a model such as a large language model (LLM). The output of the LLM may be an explanation of the operation/function of the model in natural language. Embodiments of the invention are discussed in the context of feature importance and correlation analysis to identify complex associations or correlations among features.

Embodiments of the invention are further discussed in the context of predictive maintenance but are not limited thereto. Predictive maintenance may be performed for computing equipment and systems. The ability to predict a problem or issue that is expected to occur in computing equipment or computing systems (e.g., hard drive failure) allows proactive remedial or maintenance actions to be performed (e.g., hard drive replacement, data migration) before failure occurs. Thus, embodiments of the invention advantageously improve product quality, product reliability, customer satisfaction, and the like.

Dell Technologies CloudIQ solution, for example, provides a cloud based AIOps application for core, edge, and cloud environments. This approach leverages proactive monitoring, machine learning, and predictive analytics to enable quick action and streamline operations for on-premises infrastructure and data in the cloud. Storage Manager is an example of a tool that allows for monitoring, managing, and analyzing Storage Center SANs, FluidFS clusters, and Fluid Cache clusters. Embodiments of the invention improve these types of solutions by integrating feature importance operations, correlation operations, and prompt building with LLMs.

Embodiments of the invention relate to prescriptive analysis capabilities with human-like explanations, feature engineering techniques, and the capacity of semantic analysis of the LLMs. Embodiments of the invention enhance the accuracy and flexibility of data analysis, resulting in more accurate predictions (e.g., failure predictions) before failure occurs. Embodiments of the invention can reduce downtime and maintenance costs, improve equipment reliability in computing environments and beneficially impact maintenance operations in computing environments.

Natural XAI systems combine powerful language models with transparency and explainability. Embodiments of the invention relate to language models that not only generate human-like responses but also provide clear explanations for their decision-making. Embodiments of the invention help decisions made by machine learning models to be more meaningful and understandable.

Traditional XAI models improve the explainability by identifying key features that contribute to predictions. Techniques like SHAP and LIME are examples of techniques for generating explanations, assigning importance values to input features and training simpler models to approximate behavior. Although these approaches provide some benefit in domains like healthcare and finance, challenges such as the need for ample training data and addressing potential biases remain.

Large language models, such as Alpaca and Dolly, have revolutionized the field of natural language processing (NLP) by demonstrating unprecedented levels of language generation and understanding. These models are typically trained on massive amounts of text data using deep learning algorithms, which allow these models to learn complex patterns and relationships in language. The result is a highly capable language model that can perform a wide range of NLP tasks, such as text classification, question answering, and language translation.

One of the key strengths of large language models is their ability to generate human-like responses, making them useful for chatbots, virtual assistants, and other conversational artificial intelligence applications. However, as these models become increasingly powerful, concerns have been raised about their potential to generate biased or harmful content, and the ethical implications of their widespread use. Embodiments of the invention address these concerns by ensuring or improving transparency, accountability, and responsibility in decision-making processes.

LLM prompts include providing context-specific information to an LLM to generate an improved output without requiring extensive training or high computational resources. By incorporating additional information like context data, examples, and task-specific details into the prompt provided to the LLM, the LLM can generate more accurate and relevant responses. In embodiments of the invention, this results in an improved explanation regarding the output and, operation, and decision making of the predictive model.

This approach is useful, by way of example only, when data is scarce or when there is a need to quickly leverage projects and ideas. The collection of specific data that can be validated by system users in a user-friendly manner is also enabled. In one example, a zero-shot approach is used to harness the power of the LLM while preparing a dataset for further optimization using techniques like fine-tuning (LoRA) or prompt tuning (Prompt Tuning, Prefix Tuning, and P-tuning). More specifically, the designed prompts can be validated and saved in a validation database for fine-tuning or prompt tuning operations.

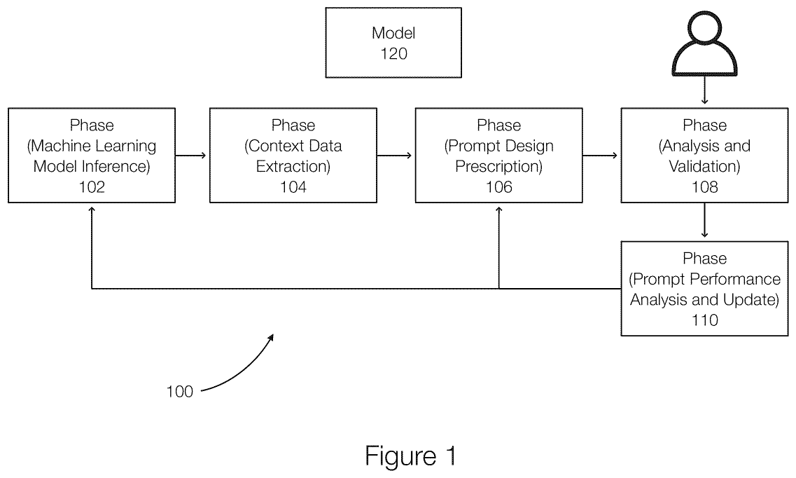

FIG. 1 discloses aspects of a prescriptive approach in machine learning or artificial intelligence. FIG. 1 illustrates a system 100 that may include multiple components or phases. The system may operate to provide, in one example, end-to-end explainability in a human-like, user-friendly, and/or natural language manner. The system 100 may include or be associated with a computing system that may include processors, memory, networking hardware and the like.

By way of example, the system 100 include a phase 102 for collecting inference data from a trained machine learning model 120. A phase 104 is configured to extract relevant information or context from the input and/or output of the model 120 to build a context prompt design. The context or relevant data extracted or selected during the phase 104 may include context or relevant information that satisfies relevant threshold requirements. The system 100 includes a phase 106 for generating a prescription analysis by a prompt design approach using the extracted context data. The phase 108 includes analyzing the prescription. Analyzing the prescription may include analyzing or evaluating the correctness of problem prediction, the usefulness of feature importance and correlations, and the adjustments or additions made to the prescription text. The system 100 may include a phase 110, which includes using a validation database to enhance the system 100. The validation database may include prompts designed and validated by the system 100.

Embodiments of the invention provide explainability, reliability and upgradability to machine learning related operations and explainability. For example, human-like explanations that are easily understandable are generated. These explanations transform the user experience. More specifically, incorporating XAI according to embodiments of the invention facilitates the extraction of context information for LLM prompts, effectively harnessing the explainability capabilities of LLMs in a zero-shot manner. The comprehension and explainability of the model's predictions builds user trust and reduces the risk of misinterpretation.

By using LLM prompts in a zero-shot manner, context data play a role in accurately guiding the explanation generated by the LLM. Embodiments of the invention include delivering reliable interpretability of the predictions using context data that may include, by way of example only, feature importance, feature correlation, and model output uncertainty. With more context data, hypotheses and explanations can be formulated more effectively, enabling a more specific and meaningful response or explanation for the user. Furthermore, a feedback loop mechanism is incorporated to continuously enhance the model performance. This helps ensure ongoing monitoring and upgrades to optimize the user experience.

In one example, data collected through user validation can be stored to create a validation database for future model refinement. Fine-tuning the model for specific tasks can significantly enhance its efficiency compared to models that are not fine-tuned. However, the availability of prescription data is often limited or nonexistent. Embodiments of the invention may include accessing models in a zero-shot manner, allowing for quick deployment and data collection while users interact with the system and generate service orders. This enables user-verified and adjusted data to be gathered to build a more comprehensive prescription database.

More specifically, the phase 102 relates to inferences generated by trained machine learning models. One objective of the phase 102 is to collect inference data (e.g., class, probability) that the model predicted. In order to ensure quality in embodiments of the invention, the machine learning model (e.g., model 120) should be capable of reliably performing the intended task. Thus, the model 120 may be trained using an appropriate training dataset. The model 120 may be any suitable type for the task or use case. By way of example, the model 120 may be Multilayer Perceptron, a Deep Neural Network, a Recurrent Neural Network, or the like.

Once the model 120 is trained, the model can be deployed and make predictions or inferences on input data x. The model then yields the predicted outcome y=f(x). To ensure the capability of the model 120, metrics such as the performance accuracy, precision, recall, or F1-score of the model 120 can be determined. These metrics can help to identify the strengths and weaknesses of the model 120 and guide the selection of appropriate thresholds for later stages or phases of embodiments of the invention. Once the model 120 is trained and reliable, for example, the model 120 is deployed.

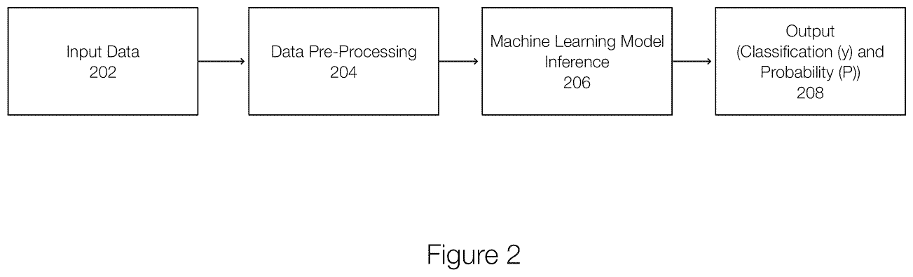

FIG. 2 discloses aspects of obtaining data related to the operation of a machine learning model. The data collected during the phase 102 may include prediction or inference data.

FIG. 2 illustrates input data 202. The input data 202 may be time series data, sample data, or the like. For example, the model 120 may be trained to predict failure of a computing system or component thereof. Thus, input data 202 may include time series data or data samples such as fan speed, CPU utilization, temperature, memory used, seek times, or other relevant data for the task.

The input data 202 is pre-processed 204 in one example prior to being input to the trained model 120. Pre-processing 204 the input data 202 may include normalization, filtering, feature engineering, and the like or combinations thereof.

Next, machine learning model inference 206 is performed using the pre-processed input data. The output 208, which may include y and a probability of a classification P may be generated by the model 120. More specifically in one example, the output 208 may be or include a SoftMax value for a classification task and a classification. The output 208 of the model can be a probability distribution for the different outcomes, represented by P (y=k|x) for k=1,2, . . . , K, where K is the number of possible outcomes. In a binary classification problem, for example, inference data that can be represented by ŷ∈0.1 is collected. The phase 102 thus includes performing inference based on input data 202 and collecting model output 208. Other data may be collected, such as the input data and/or the pre-processed input data or aspects thereof.

Returning to FIG. 1, phase 104 is performed using the data associated with the model including the inference data or output. In the phase 104, context data extraction is performed on the data collected related to the operation model 120, which may include the output 208 of the model 120.

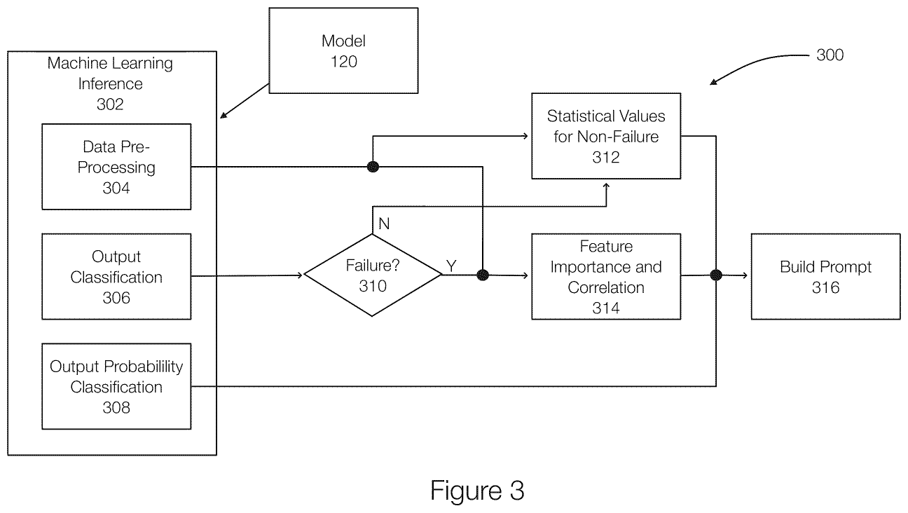

FIG. 3 discloses aspects of context data extraction from data associated with the operation of a machine learning model. One goal of the phase 104 or of context data extraction is to extract or identify context information to aid in building or designing the prompt. The method 300 is an example of extracting context data.

As illustrated in FIG. 3, a binary classification problem (failure or non-failure) is considered and the model 120 is trained to predict failure or non-failure. In this example, the machine learning inference 302 generated by the model 120 is associated with data pre-processing 304, output classification 306, and an output probability classification 308.

If the model 120 outputs a non-interesting class (e.g., non-failure=ŷ=0 or N at 310), the input data (and/or pre-processed input data) used for the inference is obtained and saved. Next, statistical values for the non-failure output are determined 312. In one example, the mean μ and the standard deviation σ of features for the non-interesting class ψ are determined.

When the model 120 outputs an interesting (e.g., failure=ŷ=1 or Y at 310) class, feature importance and correlation 314 may be performed. Feature importance may be performed using, by way of example, SHAP (Shapley Additive explanations) or LIME (Local Interpretable Model-agnostic Explanations). When performing feature importance 314, the S most important features are selected. In this example, where the model 120 is configured to predict failure/non-failure of a computing system or component thereof, the features S can include any relevant information about the prediction task, such as fan speed, CPU utilization, temperature, memory used, or other relevant, as an example.

With the S most important features, a correlation matrix C may be computed for the features that are identified by performing feature importance 314. The most correlated features are selected and included in the context data.

Once the most correlated features are selected, a prompt (e.g., an LLM prompt) is built 316 based on context information data S, C_{S}, x_{S} (denormalized and feature importance in one example), and ψₛ.

Determining feature importance is performed, in one example, to extract or determine the contribution of each feature to the model's prediction and select the most important features based on a threshold value. In one example, x∈R^{d} is an input data point with d features and f(x) is a model (e.g., the model 120) that predicts the outcome of interest based on x.

Performing or determining feature importance 314 may be achieved using a local feature importance model, such as SHAP, which is model-agnostic. In one example, the feature importance model may assign a SHAP value ϕⱼ(x) to each feature xⱼ of the input data point x, indicating the contribution of that feature to the model inference. The SHAP value is defined as the difference between the expected model output and the actual model output. The expected value is computed by averaging the model outputs over all possible subsets of features that include feature j:

$${ϕ}_{j} ( x ) = {\sum }_{S ⊆ 1 , … , d , j ∈ S} {( \begin{matrix}\vert S \vert \\ d\end{matrix} )}^{- 1} [ f ( {x}_{S} ) - f ( \overline{{x}_{S}} ) ] ,$$

where x_{S} denotes the input data point x with only the features in S, and x̅_̅{̅S̅}̅ denotes the input data point with all features except those in S.

To apply the SHAP algorithm, the input data point x is first passed through the model f(x), and the model output is used as a baseline. Then, the SHAP values are calculated for each feature x; of the input data point x. The SHAP values can be positive or negative, indicating whether the feature positively or negatively contributed to the model's prediction.

After calculating the SHAP values, the most important features are selected based on a feature selection approach, such as a threshold based on a value θ, for example. This threshold value is a hyperparameter in one example and may not be calculated. Thus, Se is a set of features with SHAP values greater than or equal to the threshold value θ, i.e., S_{θ}=j∈1, . . . , d:ϕⱼ(x)≥0. The selected features can then be used for further analysis in subsequent phases. Stated differently, the set of features Se is an example of the most important features determined by performing a feature importance operation.

Once the most important features have been determined, a correlation between feature contributions may be determined at 314. Determining the correlation is performed is to determine or calculate the correlation between the features of x and identify highly correlated features. This may be optional, as not all contexts require temporal data, but may be advantageous in some examples such as a predictive maintenance problem.

The correlation between features, in one example, is a statistical measure that indicates the degree to which two variables are linearly related. The variables are the feature contribution values of the machine learning model. By way of example and not limitation, to calculate or determine the correlation, a Pearson correlation coefficient that measures the linear correlation between two variables may be used. For each pair of features, their Pearson correlation coefficient is determined and the features with a high correlation value are selected. A high correlation value suggests that those features are co-dependent and can provide similar information about the predicted outcome.

The Pearson correlation coefficient, denoted by r, ranges from −1 to 1, where a value of −1 indicates a perfect negative correlation, 0 indicates no correlation, and 1 indicates a perfect positive correlation. The correlation value is calculated using the following formula:

$${r}_{AB} = \frac{{\sum }_{i = 1}^{N} ( {A}_{i} - \overline{A} ) ( {B}_{i} - \overline{Y} )}{\sqrt{{\sum }_{i = 1}^{N} {( {A}_{i} - \overline{A} )}^{2} {\sum }_{i = 1}^{N} {( {B}_{i} - \overline{Y} )}^{2}}} ,$$

where A and B are the two features, N is the number of data points, and ¿ denotes the sum over all data points.

The highly correlated features identified may be used to improve the prescription analysis. Including co-dependent features provides more personalized and relevant time-series information about the inferences. In one example, a hyper parameter threshold 0° C. may be used to select only relevant or most important correlations.

FIG. 3 illustrates that contextual data such as statistic values for certain classes of outputs, feature importance data, correlation data, and inference data may be collected from the model and used during the next phase 106.

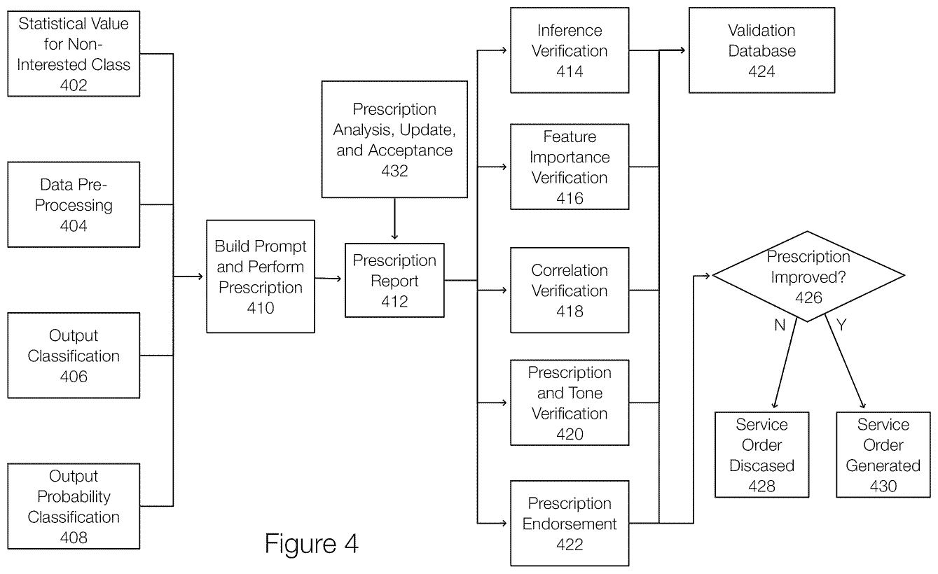

FIG. 4 discloses aspects of performing prescription analysis using prompt design with the extracted context data. When extracting context information in the phase 104, the context information related to the interesting class includes data pre-preprocessing 404 information, the output classification P 406, the output probability classification 408, and statistical values for non-interesting classes 402. These represent, more generally, the model output probability classification P, the most important features S, and strong correlation features C_{S}, and the input data x_{S}. To provide comparative analysis to the context information in one example, the statistical information for the non-interesting class (e.g., non-failure) may also be collected.

In one example, the output probability classification P 406 may adjust the tone of the response, with higher values indicating an authoritative tone or a more alert-oriented tone for lower values. Additionally, the input S is added to provide directional perspective analysis of the features related to the failure, enhancing the reasoning behind the prescription. In addition, for each feature in S, a ϕ score may be determined that can be used to tone the prescription in the problem (emphasizing or neutral tone). To aggregate more complex relationships between features, C_{S} allows the prescription approach to consider multiple sources of related data. In one example, denormalized data for the input features x_{S} and the denormalized statistical data of x_{S} the non-failure class may also be considered to provide a wider perspective for the prescription approach. These additions improve the effectiveness and reliability of the prescription approach in accordance with embodiments of the invention.

The prescription report 412, which may be generated by a model such as an LLM model, can be presented in a user-friendly format, enabling interactive exploration of the prescription generated by the LLM, such as command line interface, graphical user interface, web interface, application programming interface, among others.

Once the prompt is created and processed through the pre-trained LLM model, the phase 108 is performed. The prescription report 412 is not limited to the prescription text but may include aspects of the features. The report 412 may be analyzed 432 (e.g., by a user) to determine whether the model correctly predicted the problem and whether the feature importance information and correlation information were useful. Adjustments can also be made to the prescription text. The adjustments may be based on previous changes, and more technical details to this text, or the like.

In one example, feature importance verification 416 and correlation verification 418 are performed. This may include determining whether the selected features (the most important features) and the selected correlations (most important correlations) are relevant. Using the prescription report 412, inference verification 414, prescription and tone verification 420, and prescription endorsement 422 are also performed.

The verifications or validations (e.g., verifications 414, 416, 418, 420, 422) and the prescription (or prescription report 412) may be stored in a validation database 424. If the prescription is approved or improved (Y at 426), a service order is generated 424. If the prescription is not approved or improved (N at 428), the service order is discarded.

Verifying or validating the prescriptions enables the creation of a prescription or validation database 424 in a flexible and soft manner, as, in one example, the user may need to validate each part of the prescription report 412 to generate a service order. User validation data stored in the validation database 424 can also be used to train the inference model (e.g., the model 120) and/or fine-tune any LLMs used. This may reduce false positive alarms, and result in a more reliable prescription. With a robust validation database 424, specific approaches to train the LLM and generate more tailored responses for the user throughout the life cycle can be used.

In phase 110, prompt performance analysis and prompt updates may be performed. In the phase 110, the validation database 424 is used to conduct an analysis to enhance the predictions and prescriptions. The phase 110 may be performed periodically in order to gather a significant amount of data, ensuring a more reliable assessment of the system's performance.

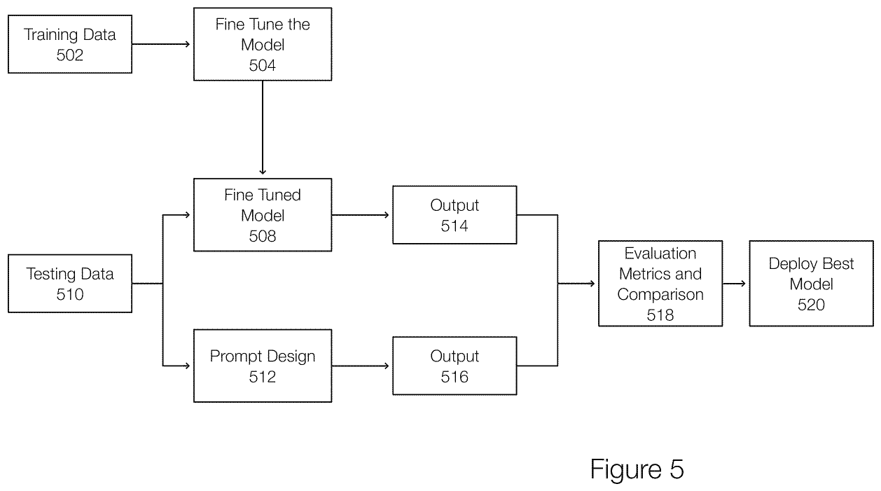

FIG. 5 discloses aspects of the performance analysis. In one example, the validation database 424 is divided into training data 502 and testing data 504. The model is fine-tuned 504 to generate a fine-tuned model 508 using the training data 502. Fine-tuning the model (e.g., the LLM model) may include LoRA, Prefix-Tuning, Prompt-tuning, and the like. The testing data 510 is offered to the fine-tuning model 508 and the prompt design 512. The output 514 generated by the model 508 and the output 516 of the prompt design 512 may be compared.

More specifically, the evaluation metrics and comparison 518 is performed. To evaluate the performance of the fine-tuned model, metrics such as perplexity, human evaluation, BLEU score, or an ensemble of these approaches can be employed. The results are then compared against those (e.g., the output 516) generated by the output 516 validated by the human. If the fine-tuning process yields superior performance, the model is deployed 520 for practical usage. However, if the fine-tuning does not outperform the human-designed prompts, adjustments are made to refine the human prompt design.

Furthermore, apart from the LLM optimization, adjustments can be made to increase or decrease the threshold for the feature importance score and correlation to adapt to more user analysis experience. The user-verified data can be leveraged to optimize the classifier given that the prescription model depends on the classifier output.

For example, in a manufacturing industry, unexpected equipment failures can lead to costly downtime and disruptions to production schedules. To tackle this challenge, embodiments of the invention allow a comprehensive explainability method that enhances predictive maintenance strategies for manufacturing equipment to be performed while generating a dataset for future model optimization.

Embodiments of the invention may use models, such as neural networks, to classify whether an equipment will fail based on historical time-series data features collected from sensors and other relevant sources. The model is classified between failure and not failure, and a probability of failure for each individual piece of equipment is determined.

Using explainability techniques, feature importance scores are determined to detect the factors influencing failure predictions classifier. This empowers maintenance engineers to identify the key features that significantly impact the expected outcomes, facilitating informed decision-making. Furthermore, the correlation between time-series data features is assessed. By uncovering highly correlated features, insights into potential dependencies and relationships among the equipment variables that may contribute to failures are obtained.

By integrating the outputs of the machine learning model, feature importance scores, and feature correlation analysis, a context-sensitive prompt design is generated. This prompt delivers human-like explanations of anticipated equipment failures, shedding light on critical factors and potential causes behind them.

Advantageously, enhanced explainability is achieved by offering transparent and easily understandable explanations for the machine learning model's predictions. This clarity enables actionable insights to be identified based on the contextual I information accompanying the predictions. Additionally, a comprehensive database of prescribed solutions for the system is generated. This accumulation of prescription data enables the creation of a unique tool that provides more reliable and tailored responses compared to other offerings.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, machine learning related operations, prescriptive operations, prescription analysis operations, natural language operations, predictive operations, context prompt design operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: extracting context data from inference data, the context data including a set of most important features and a set of correlated features, wherein the inference data including input data to a model, an output of the model, and a probability of the output, building a prompt using the context data for a large language model, performing the prompt in the large language model and generating a prescription report, and analyzing the prescription report and generating a service order when the prescription report is approved.

Embodiment 2. The method of embodiment 1, further comprising pre-processing the input data, wherein the pr-processing includes normalizing the input data, filtering the input data, performing feature engineering, or combinations thereof.

Embodiment 3. The method of embodiment 1 and/or 2, further comprising obtaining the inference data.

Embodiment 4. The method of embodiment 1, 2, and/or 3, further comprising determining the most important features based on feature scores, wherein the most important features have a feature score greater than a feature threshold score.

Embodiment 5. The method of embodiment 1, 2, 3, and/or 4, further comprising determining the set of correlated features, wherein the set of correlated features are associated with a correlation score greater than a threshold correlation score.

Embodiment 6. The method of embodiment 1, 2, 3, 4, and/or 5, further comprising analyzing the prescription report to validate an inference of the model, the set of most important features, the set of correlated features, and a tone.

Embodiment 7. The method of embodiment 1, 2, 3, 4, 5, and/or 6, further comprising endorsing the prescription.

Embodiment 8. The method of embodiment 1, 2, 3, 4, 5, 6, and/or 7, further comprising storing the prescription report and validations in a validation database.

Embodiment 9. The method of embodiment 1, 2, 3, 4, 5, 6, 7, and/or 8, further comprising updating the prescription using the validation database.

Embodiment 10. The method of embodiment 1, 2, 3, 4, 5, 6, 7, 8, and/or 9, further comprising analyzing the prompt performance based on the analysis of the prescription report.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

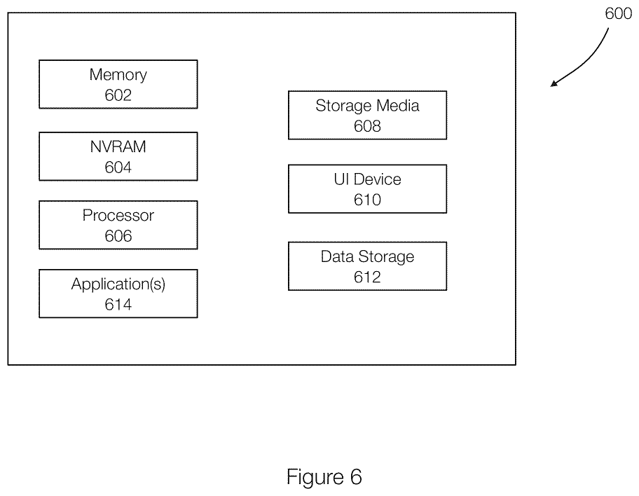

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent a physical or virtual machine or server, an edge-based computing system, a cloud-based computing system, server clusters or other computing systems or environments. The device 600 may also represent multiple machines or devices, whether virtual or physical. The device 600 may perform or execute steps or acts of the methods illustrated in the Figures.

The described embodiments are to be considered in all respects only as illustrative and not restrictive. All changes which come within the meaning and range of equivalency of the claims are to be embraced within their scope.

What is claimed is:

1. A method comprising:
extracting context data from inference data, the context data including a set of most important features and a set of correlated features, the inference data including input data to a model, an output of the model, and a probability of the output;
building a prompt using the context data for a large language model;
performing the prompt in the large language model and generating a prescription report; and
analyzing the prescription report and generating a service order when the prescription report is approved.

2. The method of claim 1, further comprising pre-processing the input data, wherein the pre-processing includes normalizing the input data, filtering the input data, performing feature engineering, or combinations thereof.

3. The method of claim 1, further comprising obtaining the inference data.

4. The method of claim 1, further comprising determining the most important features based on feature scores, wherein the most important features have a feature score greater than a feature threshold score.

5. The method of claim 1, further comprising determining the set of correlated features, wherein the set of correlated features are associated with a correlation score greater than a threshold correlation score.

6. The method of claim 1, further comprising analyzing the prescription report to validate an inference of the model, the set of most important features, the set of correlated features, and a tone.

7. The method of claim 6, further comprising endorsing the prescription.

8. The method of claim 6, further comprising storing the prescription report and validations in a validation database.

9. The method of claim 8, further comprising updating the prescription using the validation database.

10. The method of claim 1, further comprising analyzing the prompt performance based on the analysis of the prescription report.

11. A non-transitory storage medium having stored therein instructions that are executable by one or more hardware processors to perform operations comprising:
extracting context data from inference data, the context data including a set of most important features and a set of correlated features, the inference data including input data to a model, an output of the model, and a probability of the output;
building a prompt using the context data for a large language model;
performing the prompt in the large language model and generating a prescription report; and
analyzing the prescription report and generating a service order when the prescription report is approved.

12. The non-transitory storage medium of claim 11, further comprising pre-processing the input data, wherein the pr-processing includes normalizing the input data, filtering the input data, performing feature engineering, or combinations thereof.

13. The non-transitory storage medium of claim 11, further comprising obtaining the inference data.

14. The non-transitory storage medium of claim 11, further comprising determining the most important features based on feature scores, wherein the most important features have a feature score greater than a feature threshold score.

15. The non-transitory storage medium of claim 11, further comprising determining the set of correlated features, wherein the set of correlated features are associated with a correlation score greater than a threshold correlation score.

16. The non-transitory storage medium of claim 11, further comprising analyzing the prescription report to validate an inference of the model, the set of most important features, the set of correlated features, and a tone.

17. The non-transitory storage medium of claim 16, further comprising endorsing the prescription.

18. The non-transitory storage medium of claim 16, further comprising storing the prescription report and validations in a validation database.

19. The non-transitory storage medium of claim 18, further comprising updating the prescription using the validation database.

20. The non-transitory storage medium of claim 11, further comprising analyzing the prompt performance based on the analysis of the prescription report.
